(19) United States
(12) Patent Application Publication
(10) Pub. No.: US 2007/0239089 A1
(43) Pub. Date: Oct. 11, 2007

(54) Massage mechanism for massage chair

(76) Inventor: Yu-Mei Chiu, Taoyuan Hsien (TW)

Correspondence Address: BACON & THOMAS, PLLC, 625 SLATERS LANE, FOURTH FLOOR, ALEXANDRIA, VA, 22314, US

(21) Appl. No.: 11/392,592

(22) Filed: Mar. 30, 2006

(51) Int. Cl. A61H 7/00

(52) U.S. Cl. 601/99; 601/101; 601/103

(57) ABSTRACT

A massage mechanism for a massage chair includes a roller frame which includes a roller, a vibration generator and a shoulder detection device. The massage mechanism detects the precise position of a user's shoulder so that the roller and the vibration generator are moved to precise positions to massage the desired parts of the user.

### BACKGROUND OF THE INVENTION

1. Field of the Invention

The present invention relates to a massage mechanism for a massage chair, especially for a massage chair that can massage specific parts of users.

2. The Prior Arts

There are many types of massage devices such as massage chairs that use a massage mechanism received in the chair to massage users' body. The conventional massage mechanism generally includes a frame with a threaded rod which is driven to move rollers along guide rails to massage the users. Depending on the mechanisms, the rollers can be moved linearly or moved up and down to massage the users' back. However, the rollers have a fixed travel and cannot be adjusted for the travel. A longer travel may be suitable for taller users, but may not be satisfied with shorter users, and vice versa. Extra mechanisms are required if the travel of the rollers can be adjustable and the extra mechanisms occupy too much space and are costly.

The present invention intends to provide with a massage mechanism for a massage chair wherein a shoulder detection device is used to detect the position of the users' shoulders so that the mechanism can massage the users' back and shoulders no matter the users are tall or short.

### SUMMARY OF THE INVENTION

In accordance with an aspect of the present invention, there is provided a massage mechanism for a massage chair that comprises a frame. A kneading motor and a main part are respectively connected to the frame. The kneading motor connects with a first belt pulley to which a first belt is connected. A worm rod is connected to the main part and an end of the worm rod connects with a second belt pulley to which the first belt is connected. A worm wheel assembly is engaged with the worm rod. A tapping motor is installed on the frame and connects with a third belt pulley to which a second belt is connected. An eccentric shaft is connected to the main part and connected with a fourth belt pulley to which the second belt is connected. The eccentric shaft has a cam which is engaged to a connecting rod. A swing arm seat is connected to the worm wheel assembly and the connecting rod. A roller frame with a roller is connected to the swing arm seat and a vibration generator is connected to the roller frame. A shoulder detection device is connected to the roller frame.

### BRIEF DESCRIPTION OF THE DRAWINGS

The present invention will be apparent to those skilled in the art by reading the following detailed description of a preferred embodiment thereof, with reference to the attached drawings, in which:

FIG. 1 shows a massage chair with a massage mechanism of the present invention received therein;

FIG. 2 shows the massage mechanism in accordance with the present invention;

FIG. 3 shows a roller frame and a swing arm seat of the massage mechanism of the present invention;

FIG. 4 is an exploded view to show the roller frame, the swing arm seat and other parts to be connected to the roller frame and the swing arm seat;

FIG. 5 is an exploded view to show a main part and the parts on the main part; and

FIG. 6 is an exploded view of a vibration generator in accordance with the present invention.

### DETAILED DESCRIPTION OF THE PREFERRED EMBODIMENT

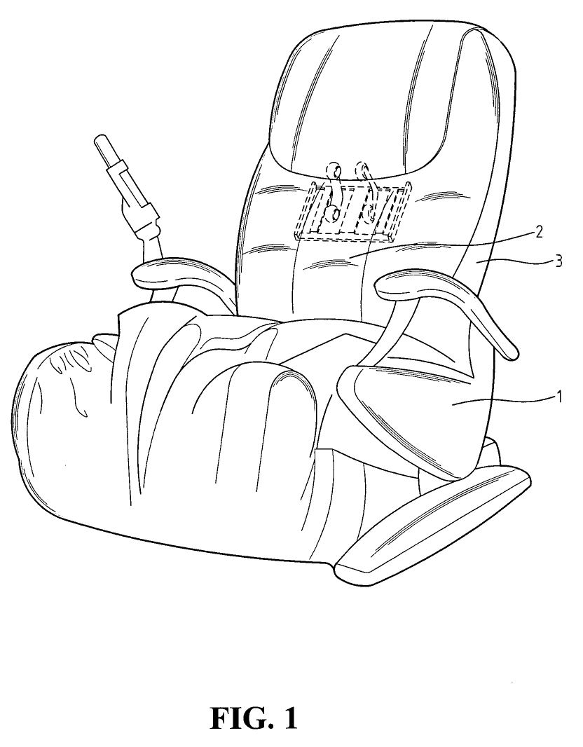

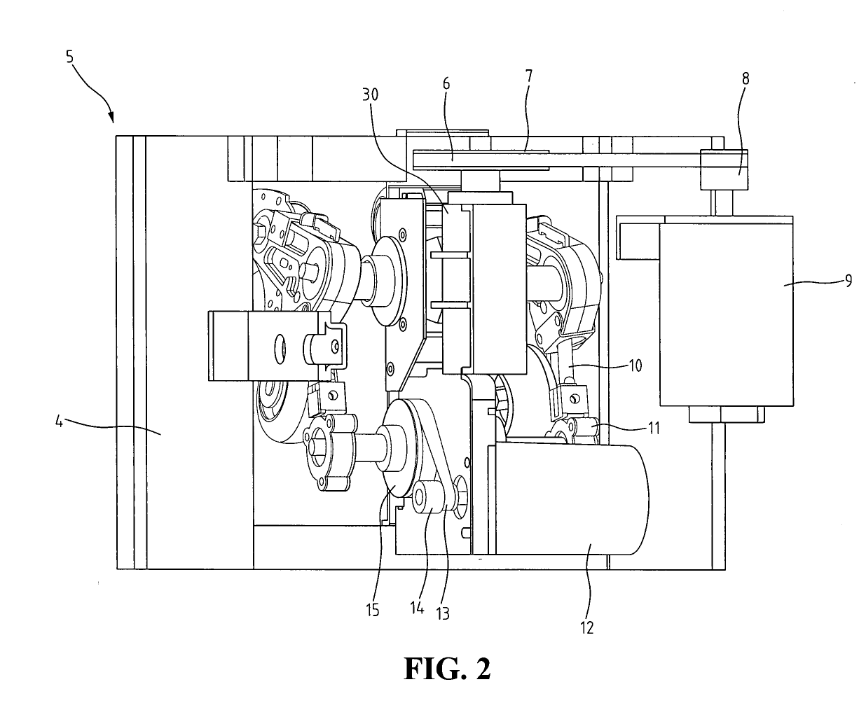

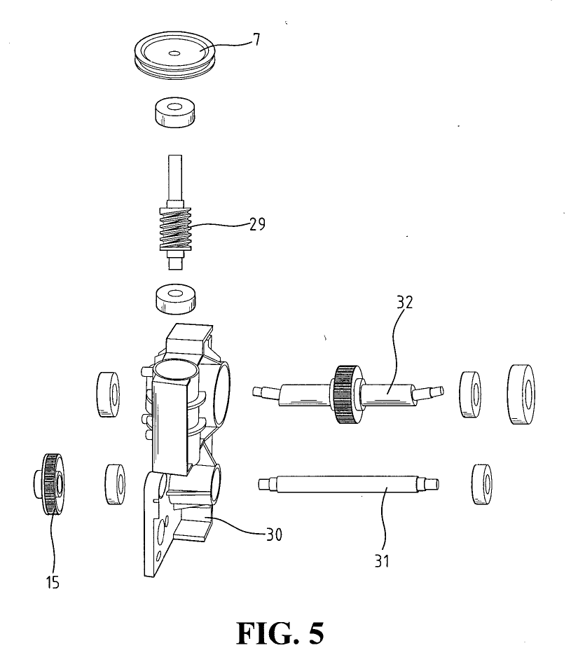

With reference to the drawings and in particular to FIGS. 1, 2 and 5, a massage mechanism 5 in accordance with the present invention is received in a backrest 3 of a massage chair 1. The massage mechanism 5 includes a kneading motor 9 installed on a frame 4. The kneading motor 9 connects with a first belt pulley 8 to which a first belt 6 is connected. The first belt 6 is connected to a second belt pulley 7 which is connected with a worm rod 29. The worm rod 29 connected to a main part 30 is engaged with a worm wheel assembly 32 connected to the main part 30.

The massage mechanism 5 further includes a tapping motor 12 installed on the frame 4 and the tapping motor 12 connects with a third belt pulley 14 to which a second belt 13 is connected. An eccentric shaft 31 is connected to the main part 30 and connected with a fourth belt pulley 15 to which the second belt 13 is connected. The eccentric shaft 31 has a cam 11 to which a connecting rod 10 is engaged.

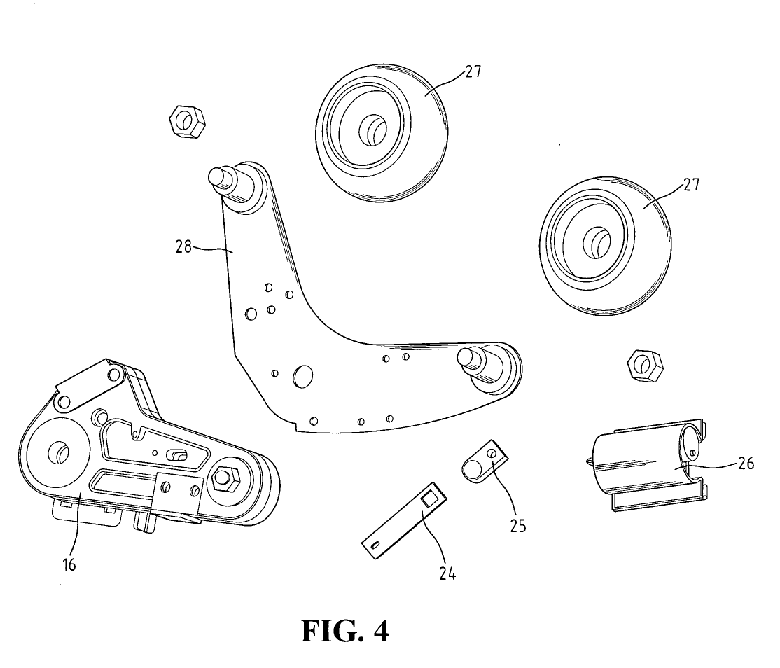

Referring to FIGS. 1, 3 and 4, the worm wheel assembly 32 and the connecting rod 10 are connected to a swing arm seat 16 which is fixed on a roller frame 28. The roller frame 28 has two rollers 27, a vibration generator 26 and a shoulder detection device 22 connected thereto. The roller frame 28 faces a support surface 2 of the backrest 3 of the massage chair 1.

The shoulder detection device 22 includes an emitting device 25 and a sensing device 24. The emitting device 25 includes a magnet 20 and a fixing plate 21 fixed on the roller frame 28. The sensing device 24 includes a PCB board 17 and a Hall sensor 18 fixed on the swing arm seat 16.

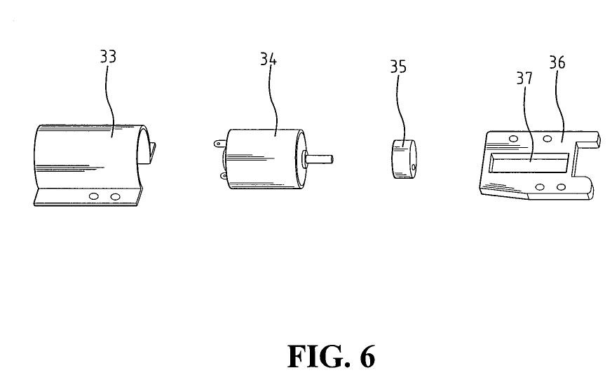

As shown in FIG. 6, the vibration generator 26 includes a cover 33, a vibration motor 34, an eccentric member 35 and a base 36, wherein the base 36 has a slot 37 and is connected to an underside of the cover 33, the vibration motor 34 is mounted inside the cover 33, and the eccentric member 35 is connected to an output shaft of the vibration motor 34.

As shown in FIGS. 1-6, when the rollers 27 are not applied by the load of a user's body through the support surface 2, the Hall sensor 18 of the shoulder detection device 22 is in an off status. When the massage chair is activated, the massage mechanism 5 moves to the user's shoulders and the rollers 27 bring the magnet 20 on the emitting device 25 of the shoulder detection device 22 on the roller frame 28 to move to generate a shift relative to the Hall sensor 18 on the sensing device 24 of the shoulder detection device 22 on the swing arm seat 16. In other words, the Hall sensor 18 senses the change of magnetic field of the magnet 20. When the change reaches a certain level, the Hall sensor 18 is activated, thereby obtaining a precise positioning on the user's shoulders.

As shown in FIGS. 1-3, in the operation of kneading, the kneading motor 9 drives the first belt pulley 8, the first belt 6, the second belt pulley 7, and the worm rod 29 one after the other. Then, the worm wheel assembly 32 engaged with the worm rod 29 drives the swing arm seat 16 and the roller frame 28 to move back and forth, so that the rollers 27 fixed on the roller frame 28 produce kneading actions to the user.

In the operation of tapping, the tapping motor 12 drives the third belt pulley 14, the second belt 13, the fourth belt pulley 15, and the eccentric shaft 31 one after the other. The connecting rod 10 connected to the eccentric shaft 31 drives the swing arm seat 16 and the roller frame 28 so that the rollers 27 fixed on the roller frame 28 move front and rear to tap the user's body.

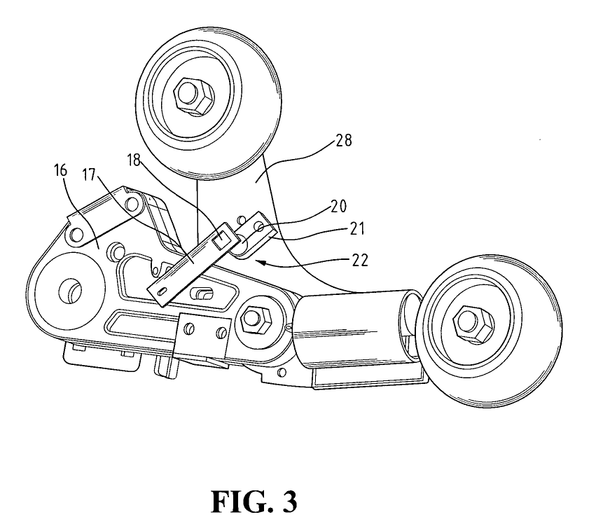

As shown in FIGS. 3-6, in the operation of vibration, the vibration motor 34 drives the eccentric member 35 to eccentrically rotate to cause vibration of the roller frame 28, so that the rollers 27 vibrate at a high frequency.

The shoulder detection device 22 allows the massage mechanism 5 to precisely massage the user's shoulders. The magnet 20 and the Hall sensor 18 are not in contact with each other directly and this ensures that the emitting device 25 and the sensing device 24 do not fail. The vibration generator 26 is located beneath the rollers 27 so that the rollers 27 can move toward the user's body and the vibration generator 26 can be operated together with the massage mechanism 5. By this arrangement, when the rollers 27 move, the user feels a high frequency of vibration and continuous tapping. This can effectively massage the user and provide with complete relaxation. The cover 33 is made of elastic material so that the vibration motor 34 can be avoided from being damaged. The base 36 is made of steel board that secures the vibration motor 34 in position, so that the vibration motor 34 cannot move both in longitudinal and lateral directions. The vibration generator 26 is connected to the roller frame 28 that is made of elastic material so that the vibration generated by the vibration generator 26 can be effectively transferred.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A massage mechanism for a massage chair, comprising:
a frame;
a kneading motor installed on the frame and connected with a first belt pulley to which a first belt is connected;
a main part installed on the frame;
a worm rod connected to the main part and an end of the worm rod connected with a second belt pulley to which the first belt is connected;
a worm wheel assembly engaged with the worm rod;
a tapping motor installed on the frame and connected with a third belt pulley to which a second belt is connected;
an eccentric shaft connected to the main part and connected with a fourth belt pulley to which the second belt is connected, the eccentric shaft having a cam which is engaged to a connecting rod;
a swing arm seat connected to the worm wheel assembly and the connecting rod;
a roller frame connected to the swing arm seat;
a roller connected to the roller frame;
a vibration generator connected to the roller frame; and
a shoulder detection device connected to the roller frame.

2. The mechanism as claimed in claim 1, wherein the vibration generator includes a cover, a vibration motor, an eccentric member and a base, the base has a slot and is connected to an underside of the cover, the vibration motor is mounted inside the cover and the eccentric member is connected to an output shaft of the vibration motor.

3. The mechanism as claimed in claim 1, wherein the shoulder detection device includes an emitting device and a sensing device, the emitting device has a magnet and a fixing plate connected on the roller frame, the sensing device includes a PCB board and a Hall sensor connected to the swing arm seat.
